(19) United States
(12) Patent Application Publication
(10) Pub. No.: US 2007/0162661 A1
(43) Pub. Date: Jul. 12, 2007

(54) Memory extension apparatus and the method of data transfer applied therein

(76) Inventors: Pei-Yuan Fu, Shulin City (TW); Chih-Chin Yang, Wufong Township (TW); Tai-Chieh Chen, Shalu Township (TW)

Correspondence Address: RABIN & Berdo, PC, 1101 14TH STREET, NW, SUITE 500, WASHINGTON, DC, 20005, US

(21) Appl. No.: 11/317,005

(22) Filed: Dec. 27, 2005

(51) Int. Cl. G06F 13/38

(52) U.S. Cl. 710/62

(57) ABSTRACT

A memory extension apparatus and the method of data transfer applied therein. The memory extension apparatus comprises a first interface, a protocol converter, a processor, a file system, a memory unit, and a trigger unit. The protocol converter receives a first command from the first electronic device via the first interface for converting the same. The processor receives the converted first command from the protocol converter, and utilizes the file system to access the memory unit for files corresponding to the converted first command. The trigger unit is for triggering the processor to generate a second command, for accessing the first electronic device through a pre-defined protocol when the trigger unit is triggered. Without sacrificing size and weight of the first electronic device, the invention provides memory extension, file backup, and file sharing without the need of an external host device.

### BACKGROUND OF THE INVENTION

1. Field of the Invention

The invention relates in general to a memory extension apparatus for portable devices, and more particularly to a memory extension apparatus for portable devices having active and passive transfer modes.

2. Description of the Related Art

With the advancement in technology, the data contained within technology products, i.e. electronic devices, has become more increasingly dynamic, taking mobile phones containing MPEG video and MP3 audio files for instance. Thus, large storage capacity has become an important consideration for buyers. Along with these demands, the issues involving memory extension, file transfer, and file backup have also become important.

In view of the foregoing, current solution to address the demand for memory space is simply to increase memory capacity. Another solution to this demand issue is to provide memory extension, by including built-in memory card readers in the electronic devices. These two methods provide a quick solution to address the demands of users for large storage capacity.

However, the drawback on the two above-mentioned methods of solution is the inevitable increase in production costs, which is reflected in the sales prices. However, the increase in prices often affects the buyers' willingness to purchase. More importantly, the implementation of built-in card readers can directly affect the physical appeals of the products, which are against the buying trend of light and compact devices.

In addition, conventional methods of file transfer, such as the transfer of files from a mobile phone to an external memory, such as a memory stick through physical connection, requires the presence of a host device acting as a controller, such as a computer. Without the computer, the transfer process can not be initiated. In addition to physical connections, another conventional method of connection is through wireless transfer, such as for transferring messages between mobile phones using multimedia messaging (MMS). However, users can not readily choose to back up data on their mobile phones to an external memory without a computer to facilitate such transfer.

Accordingly, there is a need to provide an apparatus to provide file sharing through the transfer of files, to provide file backup, and to increase memory capacity of existing electronic devices without the need for the presence of a host device to make possible such transfer.

### SUMMARY OF THE INVENTION

It is therefore an object of the invention to provide a memory extension apparatus, through the use of a file system and a pre-defined protocol, capable of selectively acting as either a host device or a client device. When acting as a host device, i.e. in an active mode, the memory extension apparatus allows users to actively direct commands to control electronic devices to initiate file transfer, memory extension, and file backup without the use of an external host device.

The invention achieves the above-identified object by providing a method of data transfer between a memory extension apparatus and a first electronic device, the memory extension apparatus comprising a first interface, a protocol converter, a processor, a file system, a memory unit, and a trigger unit, the method comprising: generating a request command by the processor when the trigger unit is triggered and the processor is triggered by the trigger unit; then, if the request command is for upload function, sending a upload command by the processor to the first electronic device through the protocol converter and the first interface, and accessing the memory unit by the processor according to the file system to obtain a first upload file for sending the obtained first upload file to the first electronic device through the first interface; next, if the request command is for download function, sending a download command by the processor to the first electronic device through the protocol converter and the first interface, and receiving a first download file from the first electronic device via the first interface; and storing the first download file by the processor in the memory unit according to the file system.

The invention achieves the above-identified object by also providing a memory extension apparatus, including a first interface, a protocol converter, a processor, a file system, a memory unit, and a trigger unit. The first interface is for providing external electrical connections to a first electronic device. The protocol converter is for receiving a first command from the first electronic device via the first interface for converting the same. The processor is for receiving the converted first command of the first electronic device from the protocol converter. The processor is to utilize the file system to access the memory unit for files corresponding to the converted first command. Trigger unit is for triggering the processor to generate a second command, for accessing the first electronic device through a pre-defined protocol when the trigger unit is triggered, where the protocol converter converts the second command and outputs the converted request command to the first electronic device via the first interface.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 illustrates a memory extension apparatus according to a first embodiment of the invention.

FIG. 2 illustrates a memory extension apparatus according to a second embodiment of the invention.

FIG. 3 illustrates a method of data transfer between a memory extension apparatus and a first electronic device according to the first embodiment of the invention of FIG. 1.

FIG. 4 illustrates another example of the method of data transfer according to FIG. 3.

### DETAILED DESCRIPTION OF THE INVENTION

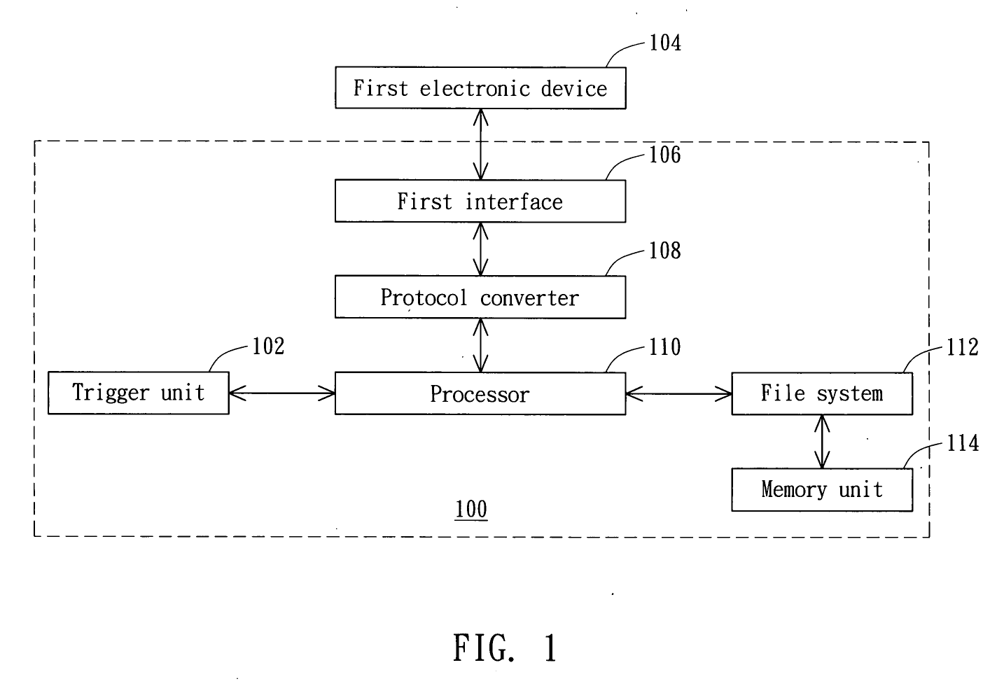

FIG. 1 illustrates a memory extension apparatus 100 according to a first embodiment of the invention. Memory extension apparatus 100 includes a trigger unit 102, a first interface 106, a protocol converter 108, a processor 110, a file system 112, and a memory unit 114. Memory extension apparatus 100 can be connected externally to a first electronic device 104, such as a mobile phone, through the first interface 106 (e.g. serial interface, parallel interface or wireless interface). The serial interface applied in the first interface 106 includes USB/RS232/RS485 interface. The wireless interface applied in the first interface 106 includes a Bluetooth interface or a WLAN interface. Protocol converter 108 is for receiving a first command from the first electronic device 104 via the first interface 106 and converting the first command to be recognizable internally in the memory extension apparatus 100. Processor 110 is for receiving the converted first command from the protocol converter 108, and utilizing the file system 112 to access the memory unit 114, such as a flash memory, for files corresponding to the converted first command. The memory unit 114 includes ATA/ATAPI devices or NAND Flash memory. The file system 112 is a data structure in an operation system (OS) and is used for naming, accessing and organizing the files. The file system 112 is capable of labeling and accessing information of the files and the lists.

Additionally, memory extension apparatus can also direct commands to the first electronic device 104 through the trigger unit 102. For instance, the trigger unit 102 is a push button or a pre-define command. When a user presses the push button, the push button in turn triggers the processor to generate a request command according to a pre-defined protocol to access the first electronic device 104. The pre-defined protocol is used to establish the memory extension apparatus 100 to act as a host device for accessing the first electronic device 104. Before outputting the request command, the protocol converter 108 converts the request command, and outputs the converted request command to the first electronic device 104 via the first interface 106. If the request command is an upload command, the processor 110 is to utilize the file system 112 to upload corresponding files, obtained from the memory unit 114, into the first electronic device 104. If the request command is a download command, the files in the first electronic device 104 are downloaded to the memory unit 114 of the memory extension apparatus 100 via the first interface 106.

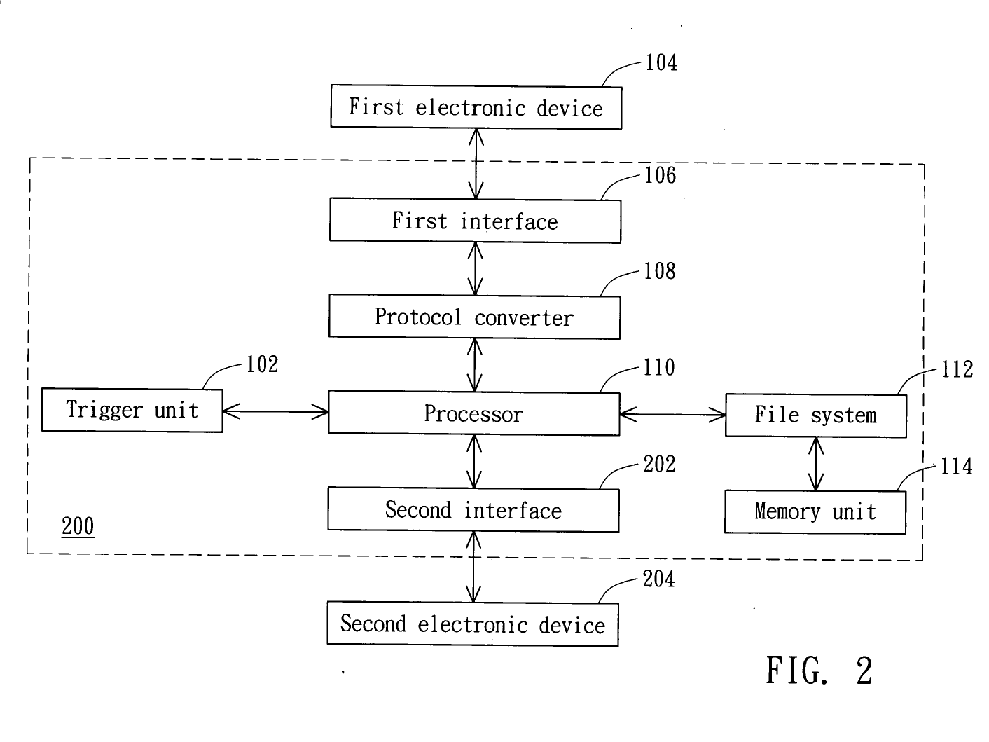

The memory extension apparatus 100 further includes a second interface 202 for providing external electrical connections to a second electronic device 204, as shown in FIG. 2 of a memory extension apparatus 200 according to a second embodiment of the invention. The memory extension apparatus 200, when connected to both the first electronic device 104 and the second electronic device 204, serves as means for transferring files between the two electronic devices.

In the two above preferred embodiments, the first interface and the second interface are not limited to wired interfaces. The invention is intended to encompass all interfaces, being wireless interfaces, such as USB interfaces and WLAN interfaces, and wired interfaces, such as serial interfaces and parallel interfaces.

Thus, as shown, one advantage of applying the memory extension apparatus according to the preferred embodiments of the invention is that when electrically connected externally to the electronic device 104, users can utilize the memory extension apparatus 100 to act as a host device, thus without the need of an external host device such as a computer acting as a controller, to direct commands to the first electronic device 104. For instance, in case of a download command, users can readily back up files from the first electronic device 104 by storing in the memory unit 114 utilizing the trigger unit 102, thus effectively achieving file backup.

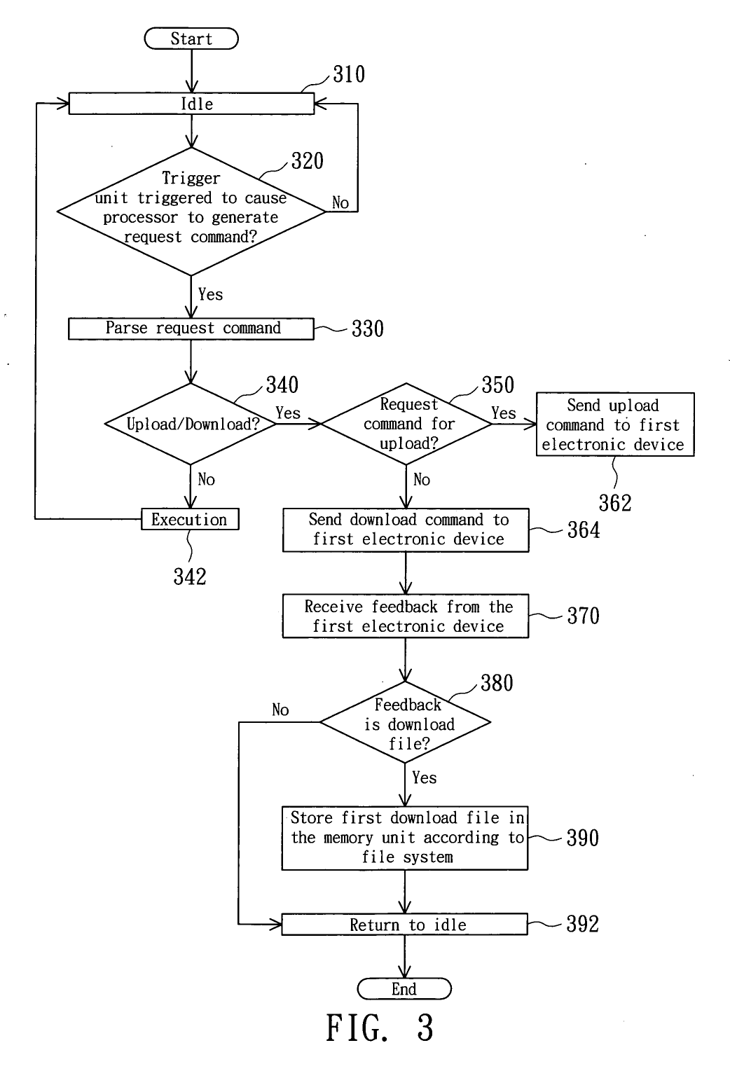

FIG. 3 illustrates a method of data transfer between a memory extension apparatus 100 and a first electronic device 104 according to the first embodiment of the invention of FIG. 1. The method according to the first embodiment begins at step 310, where memory extension apparatus 100 is at an idle state waiting for the trigger unit 102 to be triggered. Step 320 is performed to detect whether the trigger unit is being triggered. If not, the memory extension apparatus returns to step 310 to the idle state. If the trigger unit is indeed triggered to cause the processor 110 to generate a request command, step 330 is then performed for the processor 110 to parse the request command. Then, in step 340, if the request command is determined to be neither for upload function or download function, but instead for suspend (i.e. for returning memory extension apparatus 100 to idle state), wakeup (i.e. for causing memory extension apparatus to get out of idle state), or change storage (i.e. for indicating memory unit 114 is full in memory capacity) function, then step 342 is proceed to utilize the processor 110 to execute the request command to perform above-mentioned tasks accordingly, and then return to step 310 idle state until trigger unit is triggered again. Else, in case the request command is for upload function or download function, step 350 is performed. If the request command is for upload function, then step 362 is performed to send a upload command by the processor 110 to the first electronic device 104 through the protocol converter 108 and the first interface 106, and accessing the memory unit 114 by the processor 110 according to the file system 112 to obtain a first upload file for sending the obtained first upload file to the first electronic device 104 through the first interface 106.

If the request command is for download function, then step 364 is performed for sending a download command by the processor 110 to the first electronic device 104 through the protocol converter 108 and the first interface 106, and receiving a first download file from the first electronic device 104 via the first interface 106. Next, in step 370, memory extension apparatus 100 receives feedback from the first electronic device 104. Then, step 380 determines whether the feedback is the download file. If yes, then step 390 is performed for storing the first download file by the processor 110 in the memory unit 114 according to the file system 112. If not, then the memory extension apparatus 100 returns to the idle state indicative of step 392.

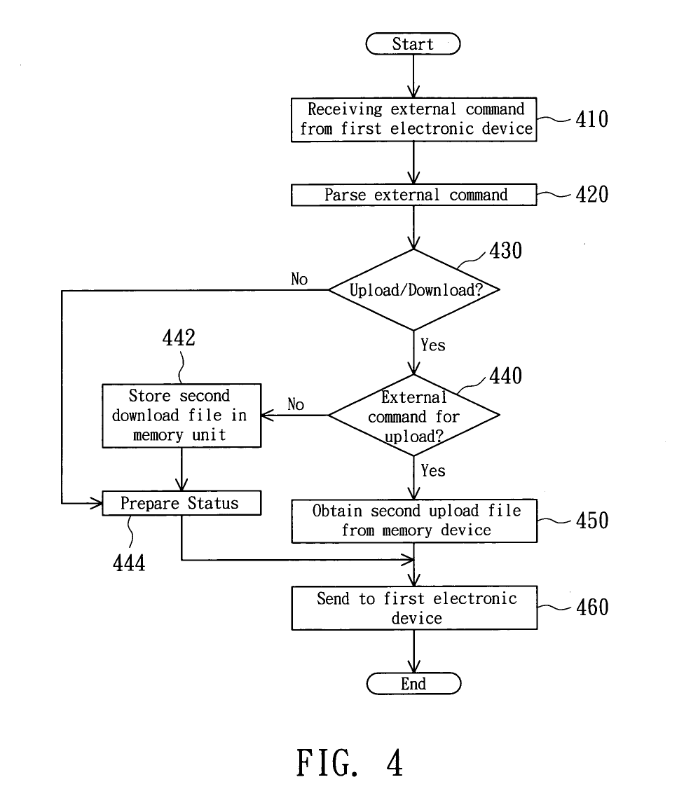

Furthermore, the method of data transfer between the memory extension apparatus and the first electronic device can further include the following steps, as shown in FIG. 4, when the memory extension apparatus 100 acts as a client device to receive from the first electronic device 104, which acts as a host device. The steps begin when the memory extension apparatus 100 receives an external command by the processor 110 from the first electronic device 104 through the protocol converter 108 and the first interface 106 in step 410. Next, in step 420, the external command is parsed. Then, step 430 is performed to determine whether the external command is for upload or download function. If not, being that the external command contains no data address and does not require file system 112 for execution, but rather is for non-memory-access related commands, such as for suspending or waking up the memory extension apparatus 100, or informing that memory capacity of memory unit 114 is full, then step 444 is proceed to perform the corresponding operations and return status of the memory extension apparatus 100 (i.e. state busy, state complete etc.) to be output to the first electronic device 104 in step 460. However, if the external command is determined to be for either upload function or download function, then step 440 is performed, for determining whether the external command is for upload function. If yes, in 450, processor 110 is utilized to obtain a second upload file from the memory unit 114, and in step 460, to send the second upload file to the first electronic device 104 through the first interface 106.

If not, being that the external command is for download function, then step 442 is carried out to store a second download file transmitted with the external command by the processor 110 to the memory unit 114. Then, step 444 and 460 are respectively performed to prepare for the status of the memory extension apparatus 100 indicative of that the file transfer is complete, and send the file transfer complete status to the first electronic device 104.

As shown, according to the first embodiment of the invention, the memory extension apparatus 100 can provide an active or passive mode of transfer when being connected externally to the first electronic device 104. That is, files from the first electronic device 104 can be stored in the memory unit 114 of the memory extension apparatus 100 in the passive mode of transfer, thereby achieving the object of memory extension. Alternatively, in the active mode, users can, with the pre-defined protocol and the file system 112, utilize the trigger unit 102 to trigger the processor 110 to direct commands to the first electronic device 104, such as for downloading the files from the first electronic device 104 for storage in the memory unit 114.

Also, according to the second preferred embodiment of the invention, when being connected to the first electronic device 104 and the second electronic device 204, such as two mobile phones, the memory extension apparatus 200 can transfer files from the first mobile phones to the second mobile phones, thereby achieving the object of file sharing and file update. For instance, the memory extension apparatus can connect to a mobile phone through the first interface to back up the files from the mobile phone, and connect to a personal computer (PC) through the second interface for editing the files of the mobile phone on the PC, and later storing the edited files back on the mobile phone.

Furthermore, in another example, the memory extension apparatus 200 can also be connected to a PC through a USB interface and to a mobile phone through a Bluetooth interface, for providing as a means to transfer the commands from the PC to the mobile phone, such as for changing settings or accessing files in the mobile phone.

In overcoming conventional problems, in addition, adapting the memory extension apparatus according to the embodiments of the invention allows products designers to continue designing electronic devices that appeal to most buyers without sacrificing physical size and weight but simply by moderately editing firmware of the electronic devices to allow communication of the electronic devices with the memory extension apparatus of the present invention. While performing file sharing or update, in addition, the proposed memory extension apparatus according to the embodiments of the invention can provide active file update without the use of a host device.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A memory extension apparatus, comprising:
a file system;
a first interface, for providing external electrical connections to a first electronic device;
a protocol converter, for receiving a first command from the first electronic device via the first interface for converting the first command;
a processor, for receiving the converted first command of the first electronic device from the protocol converter;
a memory unit, wherein the processor utilizes the file system to access the memory unit for files corresponding to the converted first command; and
a trigger unit, for triggering the processor to generate a second command, for accessing the first electronic device through a pre-defined protocol when the trigger unit is triggered, wherein the protocol converter converts the second command and outputs the converted request command to the first electronic device via the first interface.

2. The memory extension apparatus according to claim 1, wherein the processor utilizes the file system to upload corresponding files into the first electronic device if the request command is a upload command, wherein the corresponding files are obtained from the memory unit.

3. The memory extension apparatus according to claim 1, wherein the files in the first electronic device are downloaded to the memory unit of the memory extension apparatus via the first interface if the request command is a download command.

4. The memory extension apparatus according to claim 1 further comprising a second interface, for providing external electrical connections to a second electronic device, wherein the memory extension apparatus serves as means for transferring files between the first electronic device and the second electronic device.

5. The memory extension apparatus according to claim 1, wherein the first interface is a serial interface.

6. The memory extension apparatus according to claim 5, wherein the serial interface is a USB/RS232/RS485 interface.

7. The memory extension apparatus according to claim 1, wherein the first interface is a parallel interface.

8. The memory extension apparatus according to claim 1, wherein the first interface is a wireless interface.

9. The memory extension apparatus according to claim 8, wherein the wireless interface is a Bluetooth interface.

10. The memory extension apparatus according to claim 8, wherein the wireless interface is a WLAN interface.

11. The memory extension apparatus according to claim 1, wherein the memory unit is ATA/ATAPI devices or a NAND Flash memory.

12. The memory extension apparatus according to claim 1, wherein the trigger unit is a push button or a pre-define command.

13. A method of data transfer between a memory extension apparatus and a first electronic device, the memory extension apparatus comprising a first interface, a protocol converter, a processor, a file system, a memory unit, and a trigger unit, the method comprising:
generating a request command by the processor when the trigger unit is triggered and the processor is triggered by the trigger unit;
if the request command is for upload function, sending a upload command by the processor to the first electronic device through the protocol converter and the first interface, and accessing the memory unit by the processor according to the file system to obtain a first upload file for sending the obtained first upload file to the first electronic device through the first interface;
if the request command is for download function, sending a download command by the processor to the first electronic device through the protocol converter and the first interface, and receiving a first download file from the first electronic device via the first interface; and
storing the first download file by the processor in the memory unit according to the file system.

14. The method according to claim 13, further comprising:
receiving an external command by the processor from the first electronic device through the protocol converter and the first interface;
if the external command is for upload function, obtaining a second upload file by the processor from the memory unit and sending the second upload file by the processor to the first electronic device through the first interface; and
if the external command is for download function, storing a second download file contained in the external command by the processor to the memory unit.
